(19) United States
(12) Patent Application Publication
(10) Pub. No.: US 2006/0001808 A1
(43) Pub. Date: Jan. 5, 2006

(54) Protection film for polarizing plate and a polarizing plate

(75) Inventor: Hironobu Shinohara, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: HS PLANNING LIMITED, Tokyo (JP)

(21) Appl. No.: 11/209,676

(22) Filed: Aug. 24, 2005

Related U.S. Application Data
(63) Continuation of application No. PCT/JP04/02067, filed on Feb. 23, 2004.

(30) Foreign Application Priority Data
Feb. 25, 2003 (JP) 2003-096528

(51) Int. Cl. G02F 1/1333

(52) U.S. Cl. 349/122

(57) ABSTRACT

Transparent resin film coated by polythiophene and polarizing plate laminated at one side or both side of the plate with this transparent film was provided for the use of protection film of polarized film. This polythiophene polymers are applied by thiophene type monomer reacted to one or both side of the synthesizing film pre-treated with oxidizing agent in gas phase polymerization.

### BACKGROUND OF THE INVENTION

1. Field of the Invention

The present invention relates to a protection film for polarizing plate which can be used for a liquid crystal display etc., and to a polarizing plate laminated with this protection film for polarizing plate. More particularly, the present invention relates to a protection film for polarizing plate where a transparent resin film coated with polythiophene polymer by gas-phase polymerization, and a polarizing plate where the protection film for polarizing plate is adhered to the polarizing film.

2. Description of the Related Art

Conventionally, the polarizing film where polyvinyl alcohol (PVA) type resin film doped by iodine or dye laminated with TAC on its both side for the purpose of protection has been used for a polarizing plate in a liquid crystal display. In resent years, hard coating layer on the surface of TAC film is often employed as a scratch prevention and anti-glared (AG) coating is performed for the prevention of flicker of the liquid crystal display. TAC film is also often coated with anti-reflection layer in order to decrease reflection ratio in the case the liquid crystal display is used for television.

Furthermore, transparency of this polarizing plate is regarded as extremely essential since it is used with a liquid crystal display. The surface of the film itself or the film coated with other materials may be coated with anti-static layer, since it is desirable to avoid dust stick on the film as much as possible. For the instance of the anti-static layer, fine particle of tin-oxide or indium-tin oxide (ITO) etc. is adhered with binder. However, it brings disadvantages of the decrease in transparency when applied by high concentration, and of the less anti-static effect when applied by low concentration. Moreover, decreasing evenness of the surface occurs since it is a fine particle, and this also causes flicker. There is another technique that applies TAC film spattered with these oxides; however, it brings some problems on which processing cost goes up sharply as well as a decrease in transparency and coloring in optical characteristics.

Although there is an alternative technique to include surfactant in TAC film as anti-static reagent, it brings several problems such as a drop of transparency, coloring, stickiness of the film surface caused by the bleeding of surfactant, and decrease in anti-static property especially under less humidity in winter.

In addition, another method for obtaining anti-static effect is introduced as following. After composing conductive polymer such as polyaniline, polypyrrole and polythiophene blended with other organic polymer material as a binder, which is strengthened its adhesion, it is pasted on the surface of the resin film. However, binder element is necessary to be more than 50% to its weight. Sometimes, it exceeds 80% to the weight in order to acquire sufficient adhesion. Therefore, the property of blended material is primarily that of the binder. It is usually necessary to thicken the coating layer to approximately several microns since it is a compound, which causes not only a drop of a transparency but coloring, decreased heat resistance and decreased moisture resistance in many cases. Moreover, an anti-static layer tends to fall off by strong rubbing. Another problem is that the polyaniline and polypyrrole colors green and gray, respectively. Although the coloring of polythiophene is less and its conductivity is higher than polyaniline or polypyrrole, it still needs to be pasted thicker or made binder concentration lower to acquire high conductivity of about 10⁴ Ω/□-10⁵ Ω/□, and these methods cause blue coloring as well as adhesion falls.

The polarizing plate is arranged on both sides of the liquid crystal part on the liquid crystal display. Therefore, TAC film generally comprises UV absorbent in the process of manufacturing to prevent the adverse effect of UV on the liquid crystal material. It has been an obstruction of obtaining a clear color in the image appeared on the display due to the yellow coloration by this UV absorbent.

### SUMMARY OF THE INVENTION

The purpose of this invention is to obtain a protection film for polarizing plate having smoothness, high transparency, little coloring, an anti-static property caused by high conductance, and low reflection function in case the composition is properly chosen, and a polarizing plate wherein this protection film for polarizing plate is applied as a protection film of a polarizing film.

The inventor reached the conclusion through earnest examination that the polarizing plate of which the protection film for polarizing plate is attached to at least one side of polarized film as a protection film can solve completely above described problems. The protection film for polarizing plate is produced by at first coating at least one side of the transparent resin film with an oxidized agent on, contacting the film with thiophene monomer in a gas phase, and thereby forming polythiophene polymer on it.

A first aspect of the invention is a protection film for polarizing plate including a polythiophene layer and a transparent resin film, wherein the polythiophene layer comprises a polythiophene polymer, wherein the transparent resin film is coated with the polythiophene layer at least on its one side surface, wherein the coating is performed by contacting thiophene monomer in gas phase to one or both side of the transparent resin film pre-coated with oxidizing agent.

A second aspect of the invention is a polarizing plate including a polarizing film and a protection film for polarizing plate, wherein the polarizing film is laminated with a protection film for polarizing plate at least on one side, wherein a protection film for polarizing plate includes a polythiophene layer and a transparent resin film, wherein the polythiophene layer comprises a polythiophene polymer, wherein the transparent resin film is coated with the polythiophene layer at least on its one side surface, wherein the coating is performed by contacting thiophene type monomer in gas phase to one or both side of the transparent resin film pre-coated with oxidizing agent.

### BRIEF DESCRIPTION OF THE DRAWINGS

FIG. 1 is a sectional view schematically showing an example of the protection film for polarizing plate according to the present invention, which includes a polythiophene layer 1 and a transparent resin film 2.

FIG. 2 is a sectional view schematically showing another example of the protection film for polarizing plate according to the present invention, which includes a polythiophene layer 1 and a transparent resin film 2 and the transparent resin film further includes one or more of functional layer 3.

FIG. 3 is a sectional view schematically showing another example of the protection film for polarizing plate according to the present invention.

FIG. 4 is a sectional view schematically showing another example of the protection film for polarizing plate according to the present invention.

FIG. 5 is a sectional view schematically showing another example of the protection film for polarizing plate according to the present invention, which further includes one or more of functional layer 3 on the polythiophene layer.

FIG. 6 is a sectional view schematically showing another example of the protection film for polarizing plate according to the present invention.

FIG. 7 is a sectional view schematically showing another example of the protection film for polarizing plate according to the present invention.

### DESCRIPTION OF THE PREFERRED EMBODIMENTS

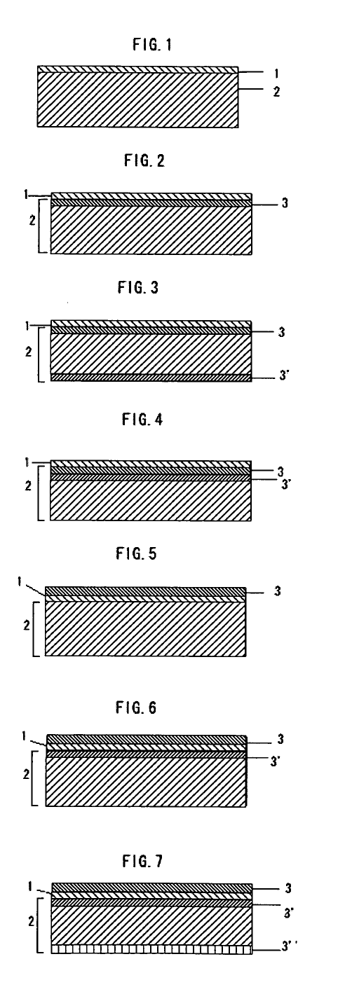

Best mode for carrying out the invention will be described below. A protection film for polarizing plate of this invention includes a polythiophene layer and a transparent resin film, wherein the polythiophene layer comprises a polythiophene polymer, wherein the transparent resin film is coated with the polythiophene layer at least on its one side surface, wherein the coating is performed by contacting thiophene monomer in gas phase to one or both side of the transparent resin film pre-coated with oxidizing agent. FIGS. 1, 2, 3, 4, 5, 6, and 7 are sectional views schematically showing an example of the protection film for polarizing plate according to the present invention, which includes a polythiophene layer 1 and a transparent resin film 2.

Since the transparent resin film of this invention is used for a liquid crystal display, the higher transparency is the more desirable. The transmission in visible light is required more than 50%, preferably over 70% and more preferably more than 80%. The transparent resin films are produced by the conventional method, for example, such as injection method, extruding method, polymerizing method in a mold and solvent casting method etc. yet the method for production is not limited to these methods. Particularly, preferable examples of the resin with good transparency include polyester resin, polycarbonate resin, polyacrylic resin, acetylcellulose resin, polyalylate resin, polyethersulphon resin and norbornene resin, etc. The form of the film, such as the shape of a roll and a sheet, is also not particularly required, and thickness is not limited yet usually 500 micron meter from 0.1 micron meter, preferably 100 from 10 micron meter. Moreover, the surface, opposite surface or both surfaces where the polythiophene in this invention is attached may shape special, such as a dot and a prism. Depending on the purposes, it may have known functional layers such as an anti-reflection layer, an anti-glared layer, dirt prevention layer, and a hard-coating layer, etc. that does not affect in quality, even if above one or several functioning layers of combination are processed on one side or both sides of the film.

Polarizing plates have a structure such that a polyvinyl alcohol (PVA) film is stretched, iodine or a dye is adhered and fixed to the stretched film to form a polarizing film, and a triacetyl cellulose (TAC) film prepared by solution flow expanding method or saponified to increase adhesiveness is adhered and fixed to both side of the polarizing film, thereby reinforcing strength of PVA film and preventing change in properties of PVA film due to water absorption. TAC has been used for protection film of polarizing film with such characteristics as excellent transparency, low birefringence, and easy adhesion to PVA. In recent years, through the movement to bigger liquid crystal display, an issue that its water absorbing property changes the size of TAC has been closed up. For this reason, the film composed by norbornene type resin that has better transparency, smaller birefringence and lower water absorbing property than TAC film has been examined as the replacement of TAC film. Transparent resin film of this invention is suitably applied with acetyl cellulose type resin such as TAC etc. and norbornene type resin for above described reasons.

Examples for acetyl cellulose type film include TAC film, cellulose diacetate film, and their modified films using cellulose fibers as raw materials. Those films are generally obtained, for example, by dissolving cellulose fibers, with ultraviolet light absorbent added in the case of necessity, in an appropriate solvent such as methylene chloride, applying the resulting solution on a stainless steel belt or an appropriate polymer film, and removing the solvent by drying the film.

The norbornene film suitably used in the present invention is not limited so long as it is a polymer obtained from at least one kind of monomers having a norbornene structure. For example, the polymer can be obtained by a method comprising the following steps: ring opening-polymerization of monomers having a norbornene structure and hydrogenation of part or whole of residual double bonds in the presence of a hydrogenation catalyst. Specific example of the polymer includes ZEONEX or ZEONOR (trade name, manufactured by Nippon Zeon Co., Ltd.) produced by the method described in, for example, Japanese Patent Application Laid-Open (JP-A) No. 63-218726, JP-A No. 5-25220 or JP-A No. 9-183832; and ARTON (trade name, manufactured by JSR Corporation) produced by the method described in, for example, JP-A No. 5-97978 or JP-A No. 1-240517.

Further example of the polymer is a polymer obtained by addition polymerization of monomers comprising a monomer having a norbornene structure and one or more of other monomers having double bonds, in the known method. Examples of such a polymer include APEL (trade name, manufactured by Mitsui Chemical Co., Ltd.) and TOPAS (trade name, manufactured by Hoechst AG) produced by the method described in, for example, JP-A No. 6-107735, JP-A No. 62-252406 or JP-A No. 8-259629.

The method of producing a film from the thus obtained polymer can be the conventional method. For example, the film can be produced by a casting method comprising dissolving a polymer in a solvent that can efficiently dissolve the polymer, specifically halogen solvent such as methylene chloride, or aromatic or alicyclic solvent, applying the resulting polymer solution to a belt made of a metal such as a stainless steel, or a polymer film such as polyester, and removing the solvent, followed by drying. The film can also be produced by an extrusion method comprising melting a polymer by heating, extruding the molten polymer on a metal belt, and cooling the same.

In producing the acetyl cellulose film or norbornene film, various additives such as antioxidants, ultraviolet light absorbers, ultraviolet light stabilizers, colorants, lubricants, antistatic agents, pigments, dyes, fibers or dispersants can be added to the polymer, if required and necessary. Where the film is used as a protective film of a polarizing plate, a film containing antioxidants, ultraviolet light absorbers and/or ultraviolet stabilizers are preferably used. These additives can be coated after the production of the film.

The surface of the film thus obtained may be coated with appropriate materials for various purposes, namely the transparent resin film further comprises one or more of functional layer. FIGS. 2, 3, 4, 6 and 7 are sectional views schematically showing example of the protection film for polarizing plate according to the present invention, which includes a polythiophene layer 1 and a transparent resin film 2 and the transparent resin film further includes one or more of functional layer 3. Coating material can be selected from any conventional materials. For example, UV curable or thermosetting curable materials such as acrylic type, urethane type, urethane acrylic type, epoxy resin type, silicone type materials, or the like can be applied to the surface of the film as hard coating agent to form a hard coating layer which prevent the surface from scratches. Films obtained by applying those hard coating materials with fine particles such as acrylic polymer particle, SiO₂ or alumina to the surface thereof, thereby reducing glare, i.e., films having anti-glared hard coating layer, can also be used. Where a film is used as a protective film of a polarizing plate, a film having the above hard coating layer or anti-glared hard coating layer on at least one side of the film is further preferably used. The film with low reflection layer is preferably provided for a liquid crystal display. The low reflection layer can be formed by coating polymer with fluorine, or combined high reflective index material and low reflective index material on the film surface. These coating layers with various functions can be used in combination by its purposes. These coating layers can also be coated on the surface of polythiophene layer as the present invention. Namely the protection film for polarizing plate further includes one or more of functional layer which is selected from the group consisting of an anti-reflection layer, an anti-glared layer, a dirt prevention layer, and a hard coating layer on the polythiophene layer. FIGS. 5, 6, and 7 are sectional views schematically showing example of the protection film for polarizing plate according to the present invention, which further includes one or more of functional layer3 on the polythiophene layer. In the case that it uses numerical coatings, the coating layer where these various functions are given can be spread in arbitrary order. An anti-reflection layer may be a low reflective index material layer or a combination of at least a high reflective index material layer and a low reflective index material layer. Examples of an anti-reflection layer are one layer type anti-reflection layer containing a low reflective index layer; two layer type anti-reflection layer containing a high reflective index layer and a low reflective index layer; and three layer type anti-reflection layer containing a high reflective index layer, a medium reflective index layer and a low reflective index layer. Furthermore a polythiophene layer may be layered between the high reflective index layer for an anti-reflection and the low reflective index layer for an anti-reflection. For example, a high reflective index layer for an anti-reflection, a polythiophene layer, and a low reflective index layer for an anti-reflection, a hard coating layer can layered in this order on a acetyl cellulose type film or norbornene type film.

Following is the explanations for the method of composing polythiophene polymer and a polythiophene layer comprises the polythiophene polymer. This method is including several steps. The first step is coating oxidant on a substrate surface of the transparent resin film or the transparent resin film pre-coated some performs to for its use as described. It is desirable to supply the film continuously with the roll in the viewpoint of productivity when coating it. For the purpose of improving adhesion of polythiophene polymer, the film can be rough surface by the pre-treatment of the film surface such as corona treatment and the plasma treatment, etc. and these treatments are often desirably applied. Moreover, it is also possible to use the film that the anchor material is coated beforehand to improve adhesion.

At least one oxidant is selected from a group consisting of transition metal compounds or strong acids of Lewis acid such as CuCl₃, iron(III) perchlorate, iron(III) toluenesulfonate, FeCl₃, and Cu((ClO₄)₂.6H₂O etc. The oxidant solution is manufactured by dissolving in a single or mixed organic solvent selected from a group consisting of water, methyl alcohol, ethyl alcohol, 2-butylalcohol, ethyl cellosolve, cyclohoexane acetone, ethyl acetate, toluene, and methyl ethyl ketone etc. Depend on a kind of the oxidant, solubility and dispersibility turn to different, and it is also possible or desirable to use mixed solvent. Although the percentage of oxidant is not limited and selected, 0.3% to 10% to total weight is preferable considering coating ability, solubility and dispersibility.

In the second step, the solution made by dissolved or dispersed oxidant is coated on the transparent resin film by the known dipping method, coating method, or printing method. The thickness of coated layer of the oxidant is selected dependant on the purpose, and it is preferable to be thin-coated at 10 Å to 100 Å of thickness. The coated film is dried in the drier at selected temperature in the consideration of the kind of the film and solvent. Generally, it is dried at the temperature in the range of 30° C. and 120° C. for a second to one hour. By the consideration of changing in quality of the film, drying speed, drying condition, it is preferably dried at between 50° C. and 80° C. for the period of between 10 seconds and 10 minutes.

Polymers as additives besides the oxidant described above may be added. The polymers are selected from a group consisting of polybutyl (meta) acrylate and its copolymers, polycarbonates, polyesters, polyurethanes, polyvinyl chlorides, polyvinyl alcohols, methyl celluloses, and chitosans, and also theirs UV curable or thermosetting curable type materials. Of course, it is possible to use a single solvent or mixed solvents. These polymers have excellent mechanic strength, excellent plasticity and high compatibility with monomers. The consistency of the polymer is not limited, but is selected from 0.1% to about 10% by total weight.

The thiophene monomer that is supplied to the film in gas phase is polymerized to form the polythiophene polymer of which structure is shown in Formula 1. Wherein, X is sulfur (S), and R1 and R2 are selected from a group consisting of hydrogen, alkyl group including 3 to 15 carbons, halogen element and benzene group. The polymer can be one kind and also the mixture among the components shown in Formula 1.

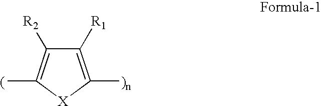

Such monomers are vaporized or supplied with the gas such as nitrogen etc to reaction room, contacted to the substrate on which the oxidant is coated, and then polymerized on the surface of the substrate. After the polymerization, thin coated layer of polymer (a polythiophene layer) is obtained on transparent resin film. The temperature condition and the reaction period must be adjusted depending on a kind and amount of pre-coated oxidant, a kind of monomer and a kind of the film etc. Generally preferable temperature condition is 0° C. to 100° C. and reaction period is 10 seconds to 40 minutes considering productivity. And then non-reacted monomers and the residue of oxidant may be removed by washing with the properly selected solvent such as water and methyl alcohol which is preferred because of its easy dryable and removable property. In the case of TAC film, contacting with the selected solvent may occur crack so that it is preferred to wash only the coated side with polythiophene or to wash it for a short time and to dry it quickly. The cleaning period of time and the cleaning condition should be controlled for removing chlorine of chloride from an oxidant completely. After the polymerization and the cleaning step with solvent, heat treatment at slightly lower or nearly equal to the glass transition temperature of the film can make the adhesion of conductive polymer on the film to be better.

Such conductive polymers of the present invention are polythiophene polymers or its derivatives having the chemical formula shown in Formula 1. The mixture of some monomers can give mixture of its polymers. The conductive polymer is thinly coated on the film substrate where thickness is controlled by polymerization condition according to the target. The thickness of a polythiophene layer is usually between 0.001 micron meter to 10 micron meter from the view of its conductivity, its transparency, its coloration, its flatness and cost of the protection film for polarizing plate. Moreover, the thickness of the film is more preferably selected from 0.05 micron meter to 5 micron meter. It is also possible to coat the mixture and in multi-layer with other conductive polymers such as polypyrrole and polyfuran as far as permission of properties.

Thus, polythiophene shown in Formula 1 is coated as thin layer on the surface of the transparent film. This polythiophene layer is single and pure component not including binder so that even the extremely thin layer keeps its high conductivity as surface resistance in between 10² Ω/□-10¹² Ω/□ easily. The thin film results in giving the coated film with little coloring and high transparency. Moreover, this invention can bring the very flat and thin layer as a merit. The layer manufactured by this invention has more excellent adhesion to the surface of the substrate and better durability for solvents such as alcohol compared with the polythiophene layer coated by a binder. It is preferred to select resistance as 10⁴ Ω/□-10¹⁰ Ω/□ for protection film of polarizing film which can be easily given by the thickness of polythiophene layer in 0.01 micron meter to 1 micron meter. As far as the application to the protection for polarizing film, it is more preferable to be selected in between 10⁵ Ω/□ to 10⁹ Ω/□ in resistance judging from all properties such as coloring, transmittance and resistance etc. Needless to say, it is possible to coat polythiophene on both surfaces of the transparent film.

The anti-static function is easily obtained in the above-mentioned resistance, and the permeability of light hardly decreases compared to the bare transparent resin film without polythiophene layer. When hard coating layer is needed, it can be coated on the layer of polythiophene or under the polythiophene layer. Moreover, when anti-reflection function is required, it only has to spread the high refraction material that has the refractive index of more than 1.55, preferably 1.60 or more (that is a high reflective index layer) on upper side of the polythiophene or hard coating layer over polythiophene and then spread the low refraction material that has a smaller refractive index (that is a low reflective index layer) on the high reflective index layer. In general, the high refraction material may be UV or thermo curable materials with metallic oxide fine particles, and which are not limited if its refractive index is 1.55 or more. As the low refraction material, it is also not especially limited but the refractive index is 1.45 or less, which can be UV or thermo curable materials including fluorine. Especially, when the liquid crystal display is for a television, the film with the anti-reflection layer can be suitably applied. Thus, it becomes an anti-reflection layer with anti-static function and is better than a conventional anti-reflection layer.

The hard coating layer, AG coating layer, the anti-reflection layer, and the strain prevention coating, etc. can be spread at the thickness from 0.01 micron meter to 50 micron meter by conventional method on the surface pre-coated with polythiophene by the method of this invention if necessary. In the case that another function layer(s) is(are) spread on the polythiophene, the conductivity of the surface is decreased, so it is desirable that the conductivity of polythiophene layer should be enhanced more than 1 to 3 orders in surface resistance value compared with the case without additional function layer(s) over the polythiophene layer. In the multi layers on the polythiophene layer, it is necessary to adjust the resistance by the thickness etc. of polythiophene layer.

Generally, the protection film of a polarizing plate is blended with the ultraviolet absorption agent in it, so that the transparency drops for a few percentages, and it is colored yellowish. Polythiophene is also found to serve as ultraviolet absorption agent therefore it does not always need to be contained with other ultraviolet absorption agent. It is desirable to use the transparent resin film which an ultraviolet absorption agent does not contain, in order to keep the transmission. Not only it leads to preventing from its coloring but it can save in expense since an ultraviolet absorption agent usually costs much.

The polythiophene layer of a protection film for polarizing plate of this invention is generally quite thin and has a flat surface, albeit it depends on the condition of production. The pencil hardness of polythiophene surface is in F or H, which is affected by the manufacturing condition of the layer, the thickness of the layer, a kind of transparent base resin film, and advanced coating etc. Generally, conventional hard coating on the polythiophene layer can be used in the case it needs for prevention from scratch on the film and it is often suitably used. Regardless to mention, its hard coating layer can be replaced with AG coating layer.

A polarizing plate of this invention includes a polarizing film and a protection film for polarizing plate of this invention, wherein the polarizing film is laminated with a protection film for polarizing plate at least on one side. Generally the polarizing film is laminated with a protection film for polarizing plate on both sides.

Such obtained protection film for polarizing plate of this invention, transparent film coated with polythiophene, is applied onto a polarizing film mainly composed of PVA by conventional agents such as hydrophilic or hydrophobic adhesives, UV curing adhesives, heat-curing adhesives by conventional method. A kind of adhesives and the way of adhesion may be properly selected judging from a kind of its surface.

The transparent resin film coated with polythiophene in this invention, keeping high anti-static property, gives high transparency, non-colored, and excellent flatness as well as excellent adhesion and durability to various solvents. Moreover, it can give low reflection function and serve as the role of ultraviolet light absorbent. Therefore, in the case it is applied for the protection film of polarizing film, a lot of above described characteristics lead to more excellent polarizing plate compared to conventional polarizing plate. Moreover plural functions of the polythiophene itself in this invention can omit some procedures in the production for polarizing plate and save some materials compared to conventional method and polarizing plate which can effectively lead to save the cost of polarizing plate.

Following is some examples for this invention, but they are not the only ones to which able to apply the invention.

### EXAMPLE 1

FeCl₃ as oxidant was dissolved in solvent, in which methyl alcohol, 2-buthyl alcohol, and ethyl cellosolve were mixed in a weight ratio of 7:2:1, of 2% by the weight. The mixture was spin-coated on TAC film of 80 micron meter thickness as transparent resin film and dried at the temperature of 65° C. for 3 minutes. The substrate, on which the oxidant was coated, was reacted in a CVD chamber designed for generating ethylenedioxythiophene monomer of a saturated state in nitrogen gas stream (by blew nitrogen gas into the solution of ethylenedioxythiophene) at the chamber temperature of 40° C. for about 1 minute. And then, the coated layer was sufficiently washed and cleaned with methanol solvent to remove non-reacted materials and residue of oxidant. As a result, TAC film on which polyethylenedioxythiophene is formed and coated of transparent and slight blue color, a protection film for polarizing plate of this invention, was manufactured. Adhesion test by cross-cut method was examined after the coated layer was cleaned with isopropyl alcohol, as a result, the coated layer does not have any peels. Thickness of the coated layer (a polythiophene layer), surface resistance, and light transmittance at wave length of 550 nm was shown in Table 1. It appears that its surface resistance was 7×10⁴ Ω/□, which showed anti-static property. Moreover, the obtained transmittance showed excellent in visible light, and ultraviolet light was absorbed.

### EXAMPLE 2

In the Example 2, a protection film for polarizing plate was produced in the same manner as Example 1, except acrylic type material of UV curing type as hard coating agent was coated on one side of TAC film at the thickness of 5 micron meter. The conductive polymer, polyethylenedioxythiophene, was attached on the HC surface under exact same condition of Example 1. The result is shown in Table 1.

### EXAMPLE 3

In the Example 3, a protection film for polarizing plate was produced in the same manner as Example 2, except the mixture of acrylic polymer and fine particle of SiO₂ was used as hard coating agent and therefore obtain a haze value of 5%. The result was shown in Table 1.

### EXAMPLE 4

In the Example 4, a protection film for polarizing plate was produced in the same manner as Example 1, except acrylic material of UV curing type including fine ZiO₂ particles where refractive index is adjusted to 1.65 with the thickness of 100 nm was coated on the one side of TAC film. The conductive polymer was attached on the side of coated ZiO₂ of TAC film at the exact same way of Example 1. The result was shown in Table 1.

### EXAMPLE 5

In Example 5, Hard coating was performed by the way of Example 2 on the surface of the protection film for polarizing plate obtained in Example 1 at the side of the layer where the conductive polymer was attached. The result was shown in Table 1.

### EXAMPLE 6

In Example 6, a protection film for polarizing plate was produced in the same manner as Example 1, except the conductive polymer was attached on TAC film including 5% by weight of ultraviolet light absorption agent. The result was shown in Table 1.

### EXAMPLE 7

On the hard coating film of a protection film for polarizing plate obtained in the Example 5, acrylic material of UV curing type including ZiO₂ particles with reflective index was coated at the thickness of 100 nm, dried at 60° C. for one hour and then cured by UV light. Moreover the material containing fluorine with 1.40 of reflective index was spread at the thickness of 100 nm on the pre-coated surface, and cured at the temperature of 80° C. The transmittance at wave length of 550 nm was 95.3%, the resistance was 9×10⁸ Ω/□, and reflection ratio of the coated surface was 0.6%. It made appear that the manufactured film had good characters of low reflection, anti-static function, difficulty of scratching.

### COMPARATIVE EXAMPLE 1 AND 2

In Comparison Example 1, TAC film which does not include ultraviolet light absorption agent was used and in Comparison Example 2, TAC film which includes ultraviolet light absorption agent was used. Both films are coated without the conductive polymers. The result was shown in Table 1.

### EXAMPLE 8

The conductive polymer was attached on Arton film of JSR Corporation manufactured by casting method at the thickness of 100 nm without ultraviolet light absorption agent. The applied method was the exact same as the Example 1 except at the temperature of 30° C. for 30 minutes for the evaporation of the conductive monomer. The result was shown in Table 1.

### EXAMPLE 9

Arton film performed hard coating same as the Example 2 was attached with the conductive polymer same as the Example 8, and then hard coating is performed on conductive polymer layer on the film by the same method as the Example 5. The result was shown in Table 1.

### COMPARATIVE EXAMPLE 3

In the Comparative Example 3, a protection film for polarizing plate was produced in the same manner as Example 8 except an Arton film was not coated with the conductive polymer. The result was shown in Table 1.

### EXAMPLE 10

In the Example 2, a protection film for polarizing plate was produced in the same manner as Example 1, except for using 100 micron meter thickness of ZEONOR firm (by Nihon Zeon Corporation) manufactured by extruding method instead of TAC firm. The result is shown in Table 1.

### COMPARATIVE EXAMPLE 4

In the Comparative Example 4, a protection film for polarizing plate was produced in the same manner as Example 10, except a ZEONOR film was not coated with the conductive polymer. The result was shown in Table 1.

TABLE 1

| | Trans- | UV absorption | Functional layer | Poly- | Functional layer | Thickness | | Light trans- | Surface | Reflec- |
|---|---|---|---|---|---|---|---|---|---|---|
| | parent | agent in | in the | thio- | on the | of the | | mittance at | resis- | tion ratio |
| | resin | transparent | transparent resin | phene | polythiophene | polythio- | | wave length | tance | of the |
| | film | resin film | film (pre-coat) | layer | layer (post-coat) | phene layer | | of 550 nm | (Ω/□) | surface |
| Example 1 | TAC | non | non | + | non | 51 | nm | 92% | 7 × 10⁴ | 3% |
| Example 2 | TAC | non | HC | + | non | 48 | nm | 92% | 8 × 10⁴ | 3% |
| Example 3 | TAC | non | AG coat | + | non | 48 | nm | 91% | 7 × 10⁴ | 3% |
| Example 4 | TAC | non | High refractive | + | non | 46 | nm | 93% | 9 × 10⁴ | 1% |
| | | | index coat | | | | | | | |
| Example 5 | TAC | non | non | + | HC | 50 | nm | 92% | 7 × 10⁴ | 3% |
| Example 6 | TAC | + | non | + | non | 53 | nm | 89% | 6 × 10⁴ | 3% |
| Example 7 | TAC | non | non | + | HC + High refrectiv | 50 | nm | 95.3% | 9 × 10⁸ | 0.6% |
| | | | | | index coat + low | | | | | |
| | | | | | refrective index coat | | | | | |
| Comparative | TAC | non | non | non | non | 0 | nm | 92% | 10¹⁶ and more | 4% |
| Example 1 | | | | | | | | | | |
| Comparative | TAC | + | non | non | non | 0 | nm | 89% | 10¹⁶ and more | 4% |
| Example 2 | | | | | | | | | | |
| Example 8 | Arton | non | non | + | non | 23 | nm | 93% | 5 × 10⁷ | 3% |
| Example 9 | Arton | non | HC | + | HC | 20 | nm | 93% | 3 × 10⁷ | 3% |
| Comparative | Arton | non | non | non | non | 0 | nm | 93% | 10¹⁶ and more | 3% |
| Example 3 | | | | | | | | | | |
| Example 10 | ZEONOR | non | non | + | non | 44 | nm | 91% | 3 × 10⁵ | 3% |
| Comparative | ZEONOR | non | non | non | non | 0 | nm | 91% | 10¹⁶ and more | 3% |
| Example 4 | | | | | | | | | | |

What is claimed is:

1. A protection film for polarizing plate comprising:
a polythiophene layer, and
a transparent resin film,
wherein the polythiophene layer comprises a polythiophene polymer,
wherein the transparent resin film is coated with the polythiophene layer at least on its one side surface,
wherein the coating is performed by contacting thiophene monomer in gas phase to one or both side of the transparent resin film pre-coated with oxidizing agent.

2. The protection film for polarizing plate according to claim 1, wherein the transparent resin film comprises any one of acetyl cellulose type film and norbornene type film.

3. The protection film for polarizing plate according to claim 2, wherein the transparent resin film further comprises one or more of functional layer which is selected from the group consisting of an anti-reflection layer, an anti-glared layer, a dirt prevention layer, and a hard coating layer.

4. The protection film for polarizing plate according to claim 3, wherein the protection film for polarizing plate further comprises one or more of functional layer which is selected from the group consisting of an anti-reflection layer, an anti-glared layer, a dirt prevention layer, and a hard coating layer on the polythiophene layer.

5. The protection film for polarizing plate according to claim 4, wherein the protection film for polarizing plate comprises an anti-reflection layer as a outer most layer and the anti-reflection layer is a low reflective index material layer or a combination of at least a high reflective index material layer and a low reflective index material layer.

6. The protection film for polarizing plate according to claim 1, wherein the protection film for polarizing plate further comprises one or more of functional layer which is selected from the group consisting of an anti-reflection layer, an anti-glared layer, a dirt prevention layer, and a hard coating layer on the polythiophene layer.

7. The protection film for polarizing plate according to claim 6, wherein the protection film for polarizing plate further comprises an anti-reflection layer as a outer most layer and the anti-reflection layer is a low reflective index material layer or a combination of at least a high reflective index material layer and a low reflective index material layer.

8. The protection film for polarizing plate according to claim 2, wherein the protection film for polarizing plate further comprises a low reflective index layer for anti-reflection on the polythiophene layer and the transparent resin film further comprises a high reflective index layer for anti-reflection.

9. A polarizing plate comprising:
a polarizing film, and
a protection film for polarizing plate,
wherein the polarizing film is laminated with the protection film for polarizing plate at least on one side,
wherein the protection film for polarizing plate comprises
a polythiophene layer and
a transparent resin film,
wherein the polythiophene layer comprises a polythiophene polymer,
wherein the transparent resin film is coated with the polythiophene layer at least on its one side surface,
wherein the coating is performed by contacting thiophene type monomer in gas phase to one or both side of the transparent resin film pre-coated with oxidizing agent.

10. The polarizing plate according to claim 9, wherein the transparent resin film comprises any one of acetyl cellulose type film and norbornene type film.

11. The polarizing plate according to claim 10, wherein the transparent resin film further comprises one or more of functional layer which is selected from the group consisting of an anti-reflection layer, an anti-glared layer, a dirt prevention layer, and a hard coating layer.

12. The polarizing plate according to claim 11, wherein the protection film for polarizing plate further comprises one or more of functional layer which is selected from the group consisting of an anti-reflection layer, an anti-glared layer, a dirt prevention layer, and a hard coating layer on the polythiophene layer.

13. The polarizing plate according to claim 12, wherein the protection film for polarizing plate comprises an anti-reflection layer as a outer most layer and the anti-reflection layer is a low reflective index material layer or a combination of at least a high reflective index material layer and a low reflective index material layer.

14. The polarizing plate according to claim 9, wherein the protection film for polarizing plate further comprises one or more of functional layer which is selected from the group consisting of an anti-reflection layer, an anti-glared layer, a dirt prevention layer, and a hard coating layer on the polythiophene layer.

15. The polarizing plate according to claim 14, wherein the protection film for polarizing plate comprises an anti-reflection layer as a outer most layer and the anti-reflection layer is a low reflective index material layer or a combination of at least a high reflective index material layer and a low reflective index material layer.

16. The polarizing plate according to claim 2, wherein the protection film for polarizing plate further comprises a low reflective index layer for anti-reflection on the polythiophene layer and the transparent resin film further comprises a high reflective index layer for anti-reflection.
